(19) United States
(12) Patent Application Publication
(10) Pub. No.: US 2026/0030639 A1
(43) Pub. Date: Jan. 29, 2026

(54) MANAGEMENT OF USAGE AND PERMISSION REQUESTS ASSOCIATED WITH PRODUCTS IN AN INFORMATION PROCESSING SYSTEM

(71) Applicant: Dell Products L.P., Round Rock, TX (US)

(72) Inventors: Shibi Panikkar, Bangalore (IN); Thirumaleshwara Adyanadka Shama, Austin, TX (US)

(21) Appl. No.: 18/781,337

(22) Filed: Jul. 23, 2024

(51) Int. Cl. G06Q 30/018

(52) U.S. Cl. CPC G06Q 30/0185

(57) ABSTRACT

A method includes obtaining a request for generating one or more usage and permission parameters associated with a product. The method further includes applying one or more machine learning algorithms to the request to generate data for use in generating the one or more usage and permission parameters. The method also includes applying at least a portion of the generated data to an approval feedback process. The method still further includes generating the one or more usage and permission parameters responsive to the applying steps.

### FIELD

The field relates generally to information processing systems, and more particularly to techniques for managing usage and permission requests associated with products in such information processing systems.

### BACKGROUND

Enterprises, e.g., original equipment manufacturers (OEMs), typically manufacture and provide products to their customers for use in information processing systems (e.g., data centers). A data center may be located at one or more customer sites or at one or more sites otherwise under control of the customer. OEM products may include, but are not limited to, hardware products (e.g., servers, storage arrays, or components thereof), software products (e.g., operating systems, application programs, or other types of software), and combinations thereof (e.g., servers and/or storage arrays with software loaded thereon).

With respect to OEM software, for example, and specifically application programs (applications), development has evolved significantly over time with the introduction of new technologies, e.g., transitioning from mainframe to desktop applications, then to web and mobile applications, followed by single-page applications, and currently, to the integration of multiverse analytics programs and intelligent chatbots.

Despite these advancements, current applications continue to adhere to defined workflows, domain logic, and software integration practices. Domain logic is program code that encodes one or more rules that determine how data is managed, e.g., created, stored, modified, etc., in a given domain (e.g., an enterprise or other business domain). Software integration may include, but is not limited to, a process of connecting applications with one another, for example, through their respective application programming interfaces (APIs). Such workflows, domain logic, and integration practice processes may take fixed input and return fixed output. For example, current applications are built on predefined domain logic developed in programming languages that take a specific input to process. Any modifications to the domain logic necessitate corresponding changes in the applications and data stores. Additionally, recovering from error conditions is limited to options such as re-trying API calls or utilizing a queue mechanism. Current application designs often struggle to adapt to changes. As a result, such applications tend to crash and/or not operate properly, requiring extensive rework and placing an additional overhead burden on the resources (e.g., compute, storage, and network resources) of the computing system on which the applications are deployed and executed (e.g., the underlying computing system), as well as any other computing systems that support the application-executing computing system. Moreover, software that manages use, access, and functionalities by a customer of such applications (or other products) provided by an OEM or other supplier face the same or similar technical challenges.

### SUMMARY

Illustrative embodiments provide management of usage and permission requests associated with a product in an information processing system.

For example, in one or more illustrative embodiments, a method includes obtaining a request for generating one or more usage and permission parameters associated with a product. The method further includes applying one or more machine learning algorithms to the request to generate data for use in generating the one or more usage and permission parameters. The method also includes applying at least a portion of the generated data to an approval feedback process. The method still further includes generating the one or more usage and permission parameters responsive to the applying steps.

Advantageously, illustrative embodiments provide, inter alia, an improved usage and permission system that autonomously manages usage and permission validation, determination, provisioning, and the like. In some illustrative embodiments, a usage and permission system utilizes acquired knowledge through one or more artificial intelligence (AI) models (which, in some illustrative embodiments, may include one or more machine learning algorithms), and incorporate rules and a feedback correction/learning mechanism. A usage and permission system according to one or more illustrative embodiments may also include different interfaces to communicate with heterogeneous systems and/or human users in their respective languages.

These and other illustrative embodiments include, without limitation, methods, apparatus, networks, systems and processor-readable storage media.

### BRIEF DESCRIPTION OF THE DRAWINGS

FIG. 1 illustrates an information processing system configured to manage usage and permission requests in accordance with one or more illustrative embodiments.

FIG. 2 illustrates a usage and permission system according to an illustrative embodiment.

FIG. 3 illustrates a request received by a usage and permission system according to an illustrative embodiment.

FIG. 4 illustrates training data in a usage and permission system according to an illustrative embodiment.

FIG. 5 illustrates entity-value pairs in a usage and permission system according to an illustrative embodiment.

FIG. 6 illustrates other entity-value pairs in a usage and permission system according to an illustrative embodiment.

FIG. 7 illustrates an entity recognition architecture in a usage and permission system according to an illustrative embodiment.

FIG. 8 illustrates pseudocode for entity relationship resolution in a usage and permission system according to an illustrative embodiment.

FIG. 9 illustrates results of an entity relationship resolution in a usage and permission system according to an illustrative embodiment.

FIG. 10 illustrates data augmentation in a usage and permission system according to an illustrative embodiment.

FIG. 11 illustrates an approval process with a feedback loop mechanism in a usage and permission system according to an illustrative embodiment.

FIG. 12 illustrates data used for permission parameter generation in a usage and permission system according to an illustrative embodiment.

FIG. 13 illustrates a process for permission parameter generation in a usage and permission system according to an illustrative embodiment.

FIG. 14 illustrates online prompt-driven analytical processing in a usage and permission system according to an illustrative embodiment.

FIG. 15 illustrates a summary of operations in a usage and permission system according to an illustrative embodiment.

FIG. 16 shows a methodology for managing usage and permission requests for products according to an illustrative embodiment.

FIGS. 17 and 18 illustrate examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud and edge computing and storage systems, as well as other types of processing systems comprising various combinations of physical and virtual processing resources.

As mentioned, software that manages customer use, access, functionalities, etc. of applications provided by an OEM or other supplier faces technical challenges. Such software that manages usage can define various parameters. As used herein, examples of such software parameters can include usage parameters, e.g., parameters defining the number of users or devices (sometimes called “seats”) that can use the software product, or the number of instances of the software product that can be used (e.g., how many users are licensed to use the software, and what are their identities). Other examples of such software parameters can include permission parameters, e.g., parameters defining levels of access or permissions that each of the users have to the software (e.g., what functionalities of the software product are each user entitled to use). In some examples, one or more usage parameters may be defined as part of a software license or license model, while one or more permission parameters may be referred to as entitlements which can also be defined in a software license or defined separately.

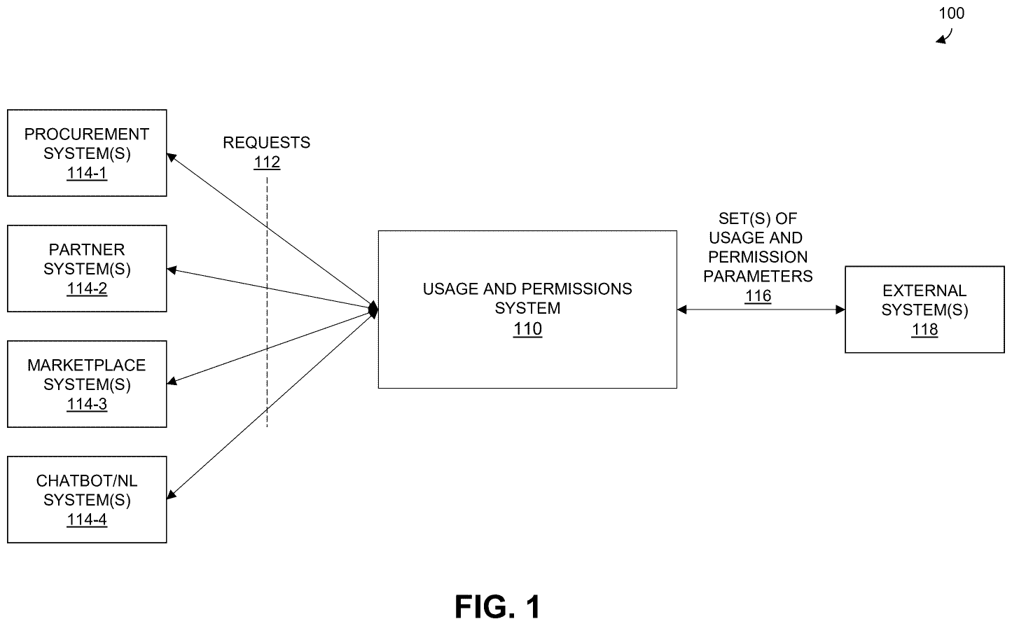

Requests to establish usage and permission parameters for software or some other OEM product can be received by the enterprise as part of customer orders, e.g., procurement orders for OEM hardware and software from various procurement systems and various formats. Requests can be enterprise partner requests, e.g., in a case where the OEM is utilizing third-party software in a piece of equipment, the partner would be the third-party software vendor—as such, many differently formatted partner requests may be received. Further, requests can also be public marketplace requests, e.g., queries from customers, vendors, or other stakeholders (e.g., Axure) or providers, each having its own input format). Still further, requests can be natural language (NL) requests from a chatbot or other software application or interface configured to replicate human conversation through computer-generated text or synthesized voice output. Examples of such request sources are depicted in FIG. 1 which is described below.

It is realized that each OEM product type requires specific permissions (e.g., entitlements), and there are variations in usage (e.g., licensing) models. For instance, some products require an XML-based key, while others rely on a third-party key such as, e.g., Flexera-based key, trial or cloud licensing model. Certain products use stored licenses, and third-party products may need to obtain licenses from their respective vendors. Each variation entails distinct business logic, workflows, and APIs. Any alterations in incoming requests have the potential to disrupt the system flow, leading to customers not receiving the specific usage and permission terms they have paid for, or the system cannot operate properly because of the unavailability of such usage and permissions parameters. This leads to a burdensome increase in system processing, storage, and networking overhead.

FIG. 1 illustrates an information processing system 100 configured to manage usage and permission requests in accordance with one or more illustrative embodiments. As shown, information processing system 100 includes a usage and permissions system 110 which receives one or more requests 112 from a plurality of sources, e.g., one or more procurement (product ordering) systems 114-1, one or more partner systems 114-2, one or more marketplace system 114-3, and one or more chatbot/NL systems 114-4. Usage and permissions system 110 generates one or more sets of usage and permission parameters in response to the one or more requests 112 and makes them available to one or more external systems, e.g., one or more of systems 114-1 through 114-4 and/or one or more other systems. In some embodiments, usage and permissions system 110 may be considered a licensing and entitlement system.

However, in existing usage and permissions systems, validation of requests is based on a fixed schema (e.g., validation fails if any other type of input other than the fixed schema is received or if there are any real-time changes to the fixed schema). Similarly, existing usage and permission systems utilize fixed rules to determine the permissions (e.g., any new attribute or change in attributes leads to a failure of permission determination). Moreover, existing usage and permission systems use fixed rules to determine the usage and fixed flows for permissions and provisioning. Even minor changes will lead an existing usage and permission system to fail. Still further, the customer user interfaces of existing usage and permission systems accept only fixed-format information and, as such, anything beyond the fixed-format information, a customer or other stakeholder needs to contact customer care of the OEM. Unfortunately, customer care personnel also may have difficulty sometimes, as permissions might not be created due to some failure.

In summary, adherence to fixed interfaces, API contracts, predefined workflows, and domain logic renders existing usage and permission systems rigid to changes. Any modifications require a substantial amount of rework, resulting in delays and in overburdening of resources (e.g., compute, storage, and network resources) of the underlying and/or supporting computing systems, as mentioned above.

Illustrative embodiments overcome the above and other technical drawbacks of existing usage and permission systems by providing an improved usage and permission system that autonomously manages usage and permission validation, determination, provisioning, and the like. In some illustrative embodiments, a usage and permissions system utilizes acquired knowledge through one or more artificial intelligence (AI) models (which, in some illustrative embodiments, may include one or more machine learning algorithms), and incorporates rules and a feedback correction/learning mechanism. A usage and permission system according to one or more illustrative embodiments may also include different interfaces to communicate with heterogeneous systems and/or human users in their respective languages.

By way of example, while existing usage and permission systems (e.g., also referred to herein as existing systems) require fixed structured requests, an autonomous usage and permission system according to one or more illustrative embodiments (e.g., also referred to herein as an autonomous system) requires no specific structure. By way of example only, requests can be in the form of a JavaScript object notation (Json) schema, an extensible Markup Language (XML) format, a natural language (NL) format, etc.

Further, while any change in the structured schema or format will crash existing systems, change in the schema does not affect the autonomous system. More particularly, in some illustrative embodiments, when there is a change in the request entity, an AI model is trained to different potential request entities for a specific permission entity. Also, even when there is a new entity, an autonomous system attempts to find the most suitable mapping, which then is submitted as an approval notification to re-train the AI model with the new entity.

In existing systems, the request field and entity field are mapped rigidly-thus, if a mapping is not found, permission creation fails. Conversely, in an autonomous system, if a mapping is not found, the autonomous system attempts to use the most suitable mapping selected based on historical data. Once the mapping is approved, it will get added to the mapping rules. Similar to mappings, variations to fixed rules (e.g., fixed rules to derive a permission type and/or a usage type) cannot be handled by existing systems. However, an autonomous system attempts to use the most suitable rule selected based on acquired knowledge and/or approval, and then the rule set can be updated. Lastly, fixed APIs in existing systems are improved in an autonomous system by utilizing NL communication to humans and structured communication to computer-based systems.

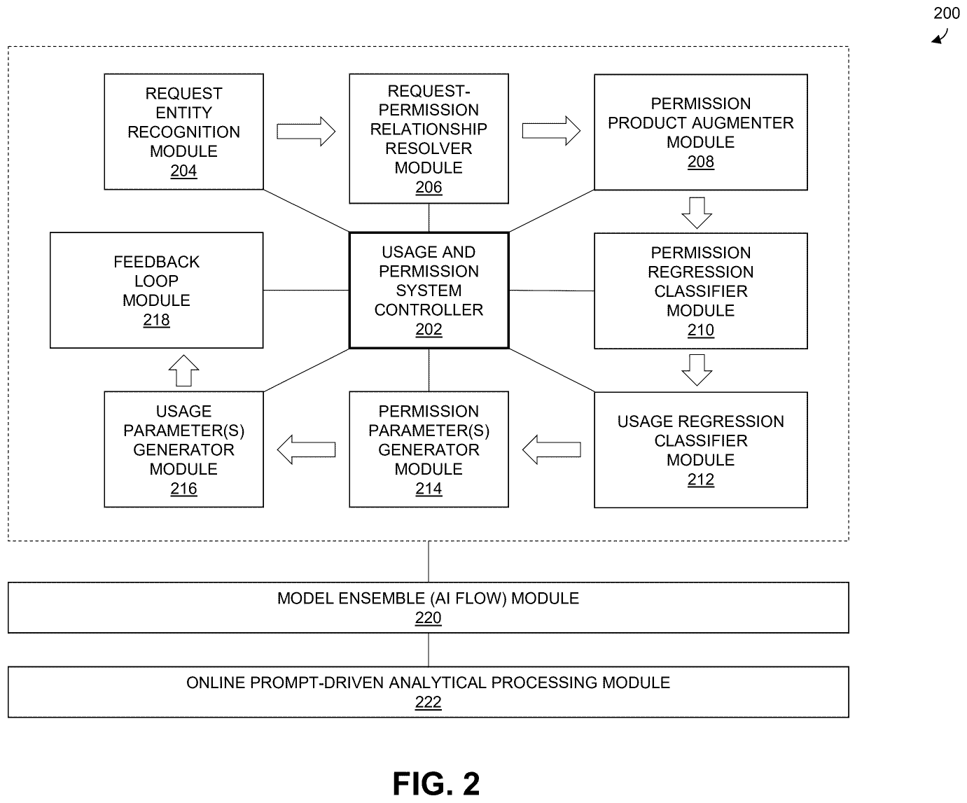

FIG. 2 depicts a usage and permission system 200 (system 200) according to an illustrative embodiment. System 200 may be considered to be an autonomous system as illustratively described above. In some illustrative embodiments system 200 may be considered an example of usage and permissions system 110 in FIG. 1.

Recall that, in some illustrative embodiments, e.g., when the product is an application or other software, the term usage can be interchanged with the term license, and the term permission can be interchanged with the term entitlement. As shown, system 200 includes a usage and permission system controller 202 (controller 202) which is configured to control various modules 204 through 222 shown in FIG. 2. Modules 204 through 222 include a request entity recognition module 204 (module 204), a request-permission relationship resolver module 206 (module 206), a permission product augmenter module 208 (module 208), a permission regression classifier module 210 (module 210), a usage regression classifier module 212 (module 212), a permission parameter(s) generator module 214 (module 214), a usage generator parameter(s) module 216 (module 216), a feedback loop module 218 (module 218) a model ensemble module 220 (module 220), and an online prompt-driven analytical processing (OPAP) module 222 (module 222).

By way of example only, in the context of a license (usage) and entitlement (permission) scenario, system 200 obtains and/or derives knowledge on various fields (e.g., entities) in a computer-based request for a license, in product order format or other request formats (e.g., Json/XML, or NL). System 200 also obtains and/or derives knowledge on the different fields required to create an entitlement. Further, system 200 obtains and/or derives knowledge to co-relate the order/request entities and entitlement entities, as well as knowledge on additional entities for creating entitlement and license. System 200 also obtains and/or determines the entities from order/licensing request and the fields needed to generate the entities that may be needed from other applications. Still further, system 200 obtains and/or derives knowledge to decide what type of entitlement needs to be created and what type of license to be applied for the entitlement. How each module 204 through 222 in system 200 is configured to contribute to the above and other functionalities will now be further described.

### Request Entity Recognizer Module (Module 204)

As mentioned above in the context of FIG. 1, a request for a license can be in the form of a sales order, partners, public marketplaces, and/or chatbot frameworks, to name a few examples. For entitlements and licensing, system 200 utilizes specific entities, e.g., product identifier, duration of the license, customer identifier, type of customer, region, country, etc. System 200 accepts the request in any format, structured (Json, XML, comma-separated values (CSV), etc.) or unstructured (e.g., NL). As such, module 204 is configured with a structured request entity recognizer configured to validate each individual format type using pre-defined schemas to identify the entities, as well as an AI-based entity recognizer to recognize the entities when not in a pre-defined schema or format. One example of an AI-based entity recognizer can utilize a Named Entity Recognition (NER) model (e.g., Spacy which is a Python-based Natural Language Processing (NLP) algorithm detects and categorizes named entities). The AI-based entity recognizer of module 204 is trained to recognize all possible sets of request entities to entitlement entities.

One example of an algorithm executed by module 204 (under control of controller 202) is as follows:
1. Check if the incoming request is structured (e.g., Json or XML);
2. If yes in step 1, get the entity and value, if no in step 1, proceed to step 5;
3. If yes in step 1, but there is a failure to extract information (due to a difference in the schema), proceed to step 4;
4. Process the NER model to get the entity based on the custom trained data, and then fetch the corresponding value; and
5. Process the NER model to get the entity and value based on the custom trained data and the NLP algorithm.

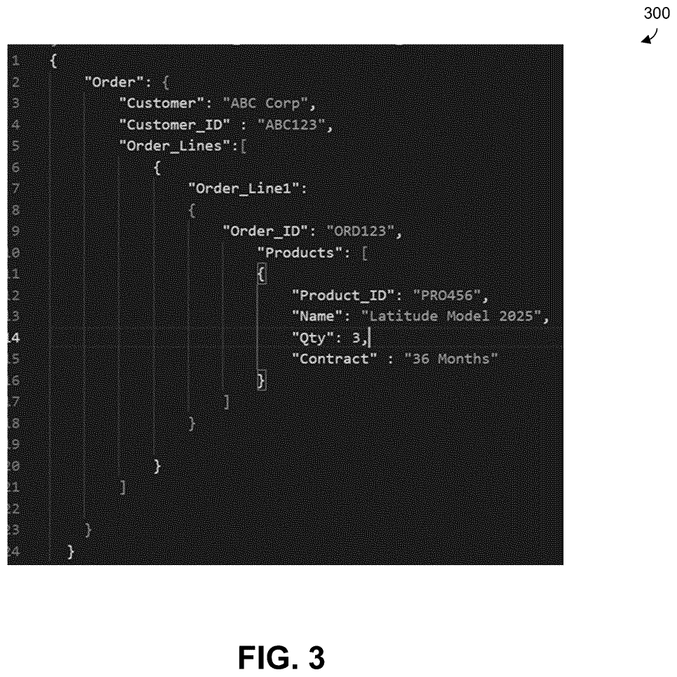

FIG. 3 illustrates an example request 300 for a license in the form of a sales order. As mentioned, the input request can be any format, however, request 300 is used a simple input example to demonstrate the entity recognition functionalities of module 204.

Request 300 is in the form of an order for a customer with a customer name and a customer identifier (ID), and includes order lines, and each order line has an order. Each order has a product and a contract specified. Thus, the various entities are: Customer, Customer_ID, Order_Lines, Order_Line1, Order_ID, Products, Product_ID, Name, and Contract. The entities required for entitlement and licensing are Product_ID, Product_Name, Quantity, Contract, Customer_ID, Customer_Name, and Order ID. Thus, these are the entities recognized from the input request.

Use case 1: Assume the input is recognized as having a Json format, then module 204 follows the pre-defined Json schema. Using the Json schema framework, module 204 obtains the entities, extracts values, and maps them to the entitlement entity.

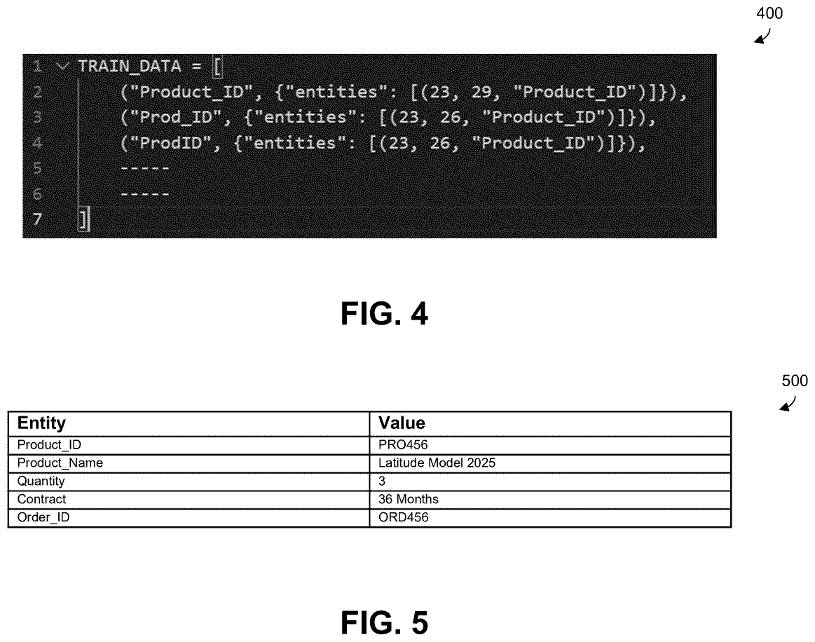

Use case 2: Assume the input is recognized as a Json format, but does not follow the pre-defined Json schema. When module 204 gets an exception, the request is passed to the NER model for Json data, e.g., Json NER Model. The Json NER Model is trained with the custom data from the Json input for all combinations as shown in training data 400 in FIG. 4.

More particularly, training data 400 shows all expected representations of the product ID that is mapped to “Product_ID” as named entity. The model is trained in the same manner for customer details, product details, order details, etc. Advantageously, even when the Json schema validation fails, the NER model can extract the entities from the Json file with its trained data. Module 204 then uses this entity name to get the value. So, the following entity-value pairs can be obtained as shown in a table 500 in FIG. 5. Note that a similar process would apply to an XML input.

Use case 3: Assume the request is in natural language. The above example can be in the form of natural language as: “My Customer ID is Cust 123, organization is named XYZ Inc. This is my Order, please issue me a license for the same. Order ID of the Order is ORD123. Order has one product with Product ID of PRO456, Product Name is Latitude Model 2025. I purchased a quantity of 3 for a 36-month contract.”

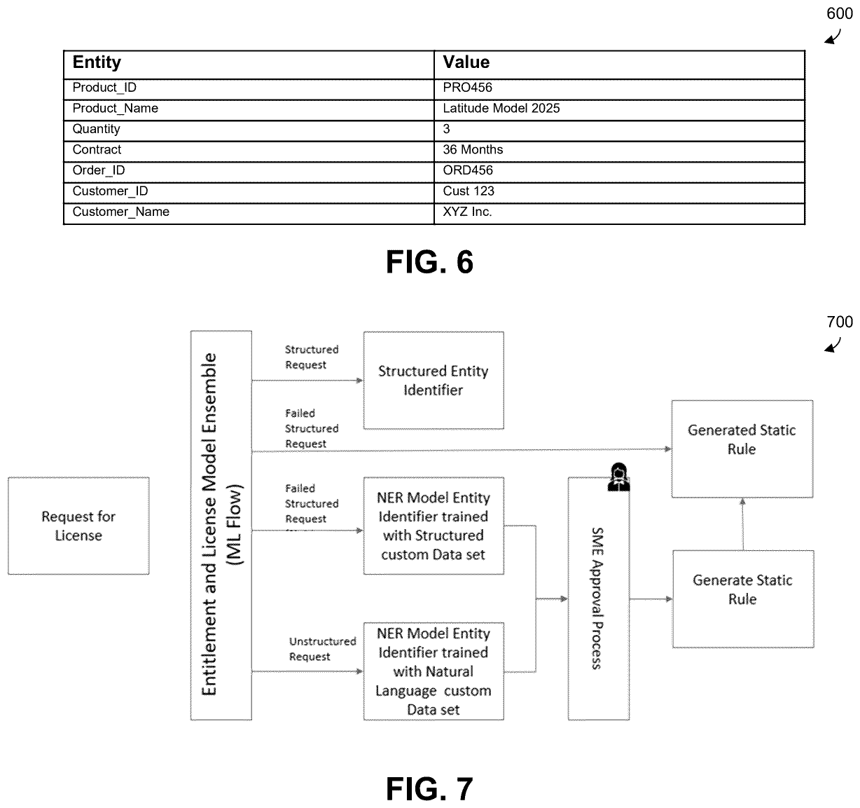

The NER model of module 204 is trained with the Entity and Value (e.g., Customer ID-Cust 123) with all possible combinations. Accordingly, module 204 generates the entity-value pairs as shown in a table 600 in FIG. 6.

In use cases 2 and 3, since there is a chance of error in AI NLP derivation, an approval process may be implemented, e.g., human intervention. The approval flow suggests the entities and the order details and includes an email or other communication mechanism for module 204 to obtain approval of the entity derivation. If approved for a specific input, system 200 generates a rule to identify the entity. A simple rule can be in the form of a Json schema.

Assume in the above example that the Json file request included Prod_ID rather than Product_ID (which is the proper Json schema). Thus, validation of the request will fail, and the request will be passed to the NER Model. The AI Model will derive the Prod_ID as Product_ID. This decision goes through the approval process with a human subject matter expert (SME). Once approved, the system generates an approved Json schema with Prod_ID. For a subsequent, similar request (a request including Prod_ID instead of Product_ID), the request will be validated, rather than going to the NER model, thus improving process speed and saving one or more underlying compute, storage, and network resources.

FIG. 7 illustrates an architecture 700 that implements the above use cases. Architecture 700 is thus configured to:
1. Identify the entities from the structure and pre-defined schema based request;
2. If failed, attempt to get the entities based on the pre-defined rules;
3. If failed, attempt to get the entities using a structured NER model, with approval flow.
If approved, the change in structure is created as an approved rule and is added to the pre-defined rules; and
4. an NL request is processed by an unstructured NER model which identifies the entities.

Advantageously, any possible variation of the input will be processed and entities will be identified. Note that while the above example illustrates an order with one product, the system can similarly process an order with multiple products.

### Request-Permission (Entitlement) Relationship Resolver (Module 206)

While module 204 determines entitlement entities from the request, module 206 determines established relationships between entitlement entities. In different entitlement solutions, relationships are maintained differently. By way of example:
1. A request ID (e.g., order ID) can have a customer and multiple products, and an entitlement for the entire quantity of products.
2. An order can have a customer and multiple products and each product can have a separate entitlement.
3. A product can have a customer, and request ID for an entitlement (e.g., relationship reversed).

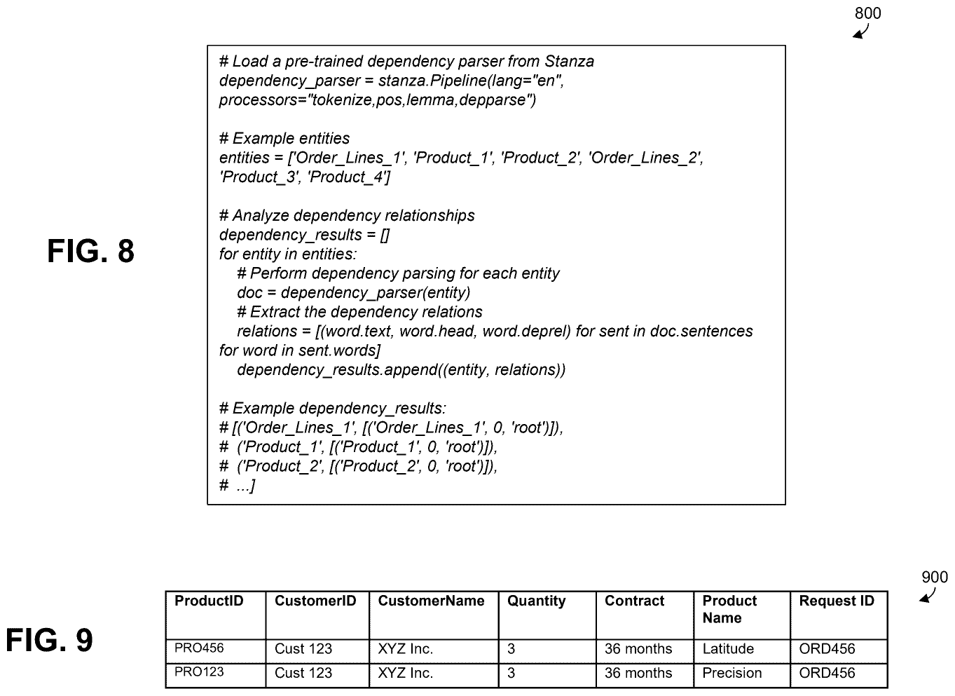

This relationship is maintained in another model. In some embodiments, a framework such as Stanza can be utilized to define the relationships between the entitlement entities. Stanza is a NER model configured to recognize relationships in entity types in a given input. FIG. 8 illustrates pseudocode 800 representing a pre-trained dependency parser. This model can be retrained for any change in the relationship.

Assume that in one entitlement system, the relationship is Product->Customer->Request ID for Quantity. With this relationship, the entitlement is as illustrated in a table 900 in FIG. 9, which maintains the relationship for the entitlement with identified entities in the request.

### Permission (Entitlement) Product Augmenter (Module 208)

Assume the request just has the product, customer, and some request details (order details). However, the entitlement details need more detail for that product to create a proper license. Accordingly, module 208 extracts information from the data source for that product if not present in the request and attempts to assess the extracted information based on historical augmentation for a specific product.

As the entities needed for entitlement do not change frequently, augmentation can be implemented as a fixed Json schema or XML schema model. If augmentation would benefit from being dynamic, Spacy annotation can be implemented as “data_source_required” for those entities.

By way of example, assume the entitlement entities to be sourced from data sources include:
Mfg_part_number (MFG)->Part number for manufacturing
License_Key_Temaple (LKT)->Template for the license
Is_Factory_Product (IFP)->License is given to factory to implement
Is_Consumer_Product (ICP)->License is given to consumer to download
Is_Third_Party_Product (ITPP)->Is this product a third-party product
Vendor_ID (VID)->Vendor ID of third-party product(s)

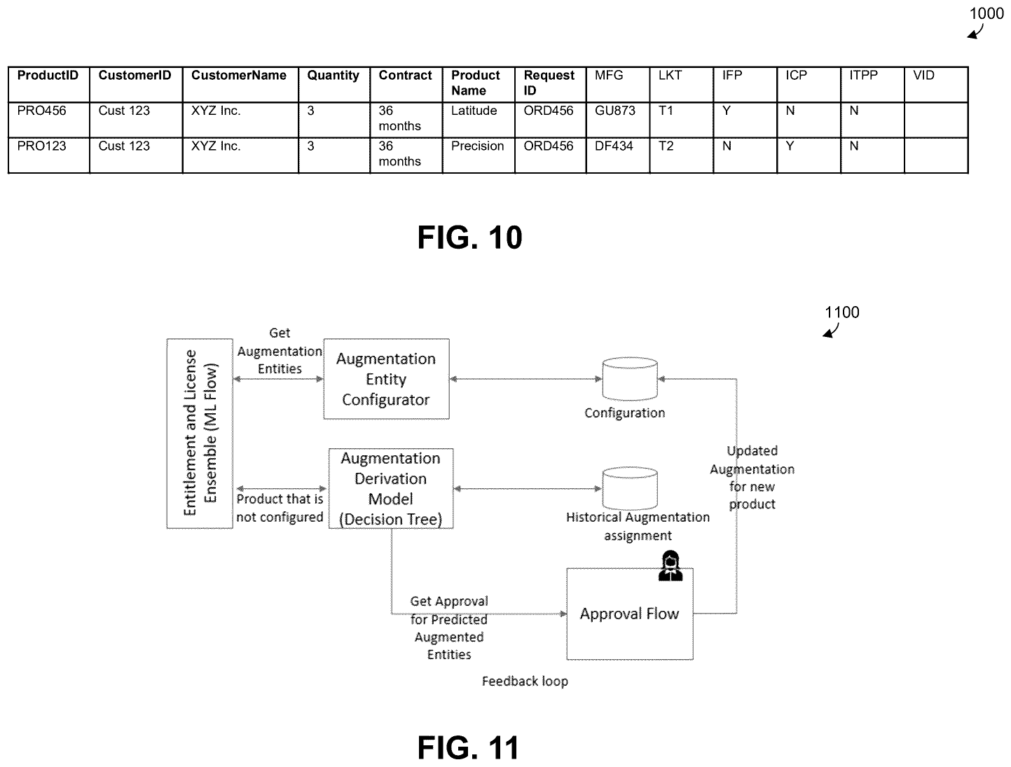

A table 1000 in FIG. 10 illustrates the above augmentation example.

Assume now that the product is not configured for augmented entities. Based on historical augmentations, an AI model can predict the augmented values in some illustrative embodiments.

Assume a new product has a Product_ID of PRO789, and this is not configured or trained in a NER model. Accordingly, module 208 performs the following process:
1. Maintain the historical augmentation of various products based on various product attributions.
2. Generate a decision tree model with weighted attributions.
3. Collect the product attributions from a product authoring application:
   a. Product ID—PRO789
   b. Product Description—Data Protection
   c. Allow Subscription—Yes
   d. Is_OEM_ABC_Product—Yes
4. Predict the augmented entities for the new product.

Consistent with the above examples, module 208 performs a process flow 1100 with feedback as shown in FIG. 11. Once the augmentation recommendation is approved, the augmentation is added to the configuration such that, for the next request, the augmentation is configured.

Accordingly, module 208 augments the entitlement data needed for creating entitlement and licensing. If the augmentation data is not configured, the decision tree model is called to obtain the most appropriate augmentation entities based on the product attribution of the new product. A decision tree model is trained based on the historical augmentation assignment for other similar products. In one non-limiting example, a multivariate adaptive regression splines (MARS) algorithm may be utilized.

### Permission (Entitlement) Regression Classifier (Module 210)

System 200 now has most of the data to create the entitlement, however, a next step is to determine what type of entitlement should be created. There are many models of entitlements based on a given set of entitlement data. Mainly there are two types of entitlements: perpetual entitlements (lifelong possession) and subscription entitlements (entitlements for a time period), with many subdivisions. In some embodiments, perpetual entitlements may include: (i) a hardware entitlement (e.g., factory installed or consumer downloadable); (ii) a first-party software entitlement (e.g., key generation, pre-build key, or cloud license); (iii) a third-party software entitlement; and (iv) a service entitlement. In some embodiments, subscription entitlements may include: (i) a hardware entitlement (e.g., factory installed or consumer downloadable); (ii) a first-party software fixed term entitlement; (iii) a first-party software consumption based entitlement; (iv) a third-party software fixed term entitlement; and (v) a third-party software consumption based entitlement.

The different models are classified based on the entitlement entities. A regression classification model is used to classify the historical data with labelled segregation. In some embodiments, for example, a random forest regression classification model can be used.

In an initial stage, a human SME can be added into the approval process for the entitlement model for a specific product and customer. Once approved, a rule is generated for the product. The next time the same product is considered, the random forest regression classification model is not called, rather the newly generated rule is applied.

Given the classification model and generated rule, the entitlement type is derived. If the rule is not present, module 210 uses an AI model to derive the rule, and once approved, adds the rule to the rule set.

### Usage (License) Regression Classifier (Module 212)

There are a variety of licensing models that are applicable for different products. Some examples include key generator type models (e.g., Flexera-based key, XML-based key, homomorphic encryption-based key, etc.) and pre-built models (e.g., stocked license-based key, cloud licensing-based key, etc.).

The key generator model is typical for the first-party licenses (e.g., OEM software) and different products demand different parameters to be passed. In one illustrative embodiment, module 212 performs the following process:
1. Use a random forest classifier to classify the license model based on the entitlement entities.
2. Get the license model for a requested product based on the entitlement entities.
3. Use approval process to approve the licensing model for the given entitlement entities.
4. Once approved, create the static rule against the entitlement entities.
5. From next call for the similar product and similar entitlement entities, get the licensing model from the rule, rather than using the random forest model.

### Permission Parameter(s) (Entitlement) Generator (Module 214)

Now system 200 has the details to generate the entitlement for the customer who requested the license. Accordingly, module 214 performs two processes: (i) entitlement generation for the customer queries in natural language; and (ii) entitlement details for the other computer-based applications.

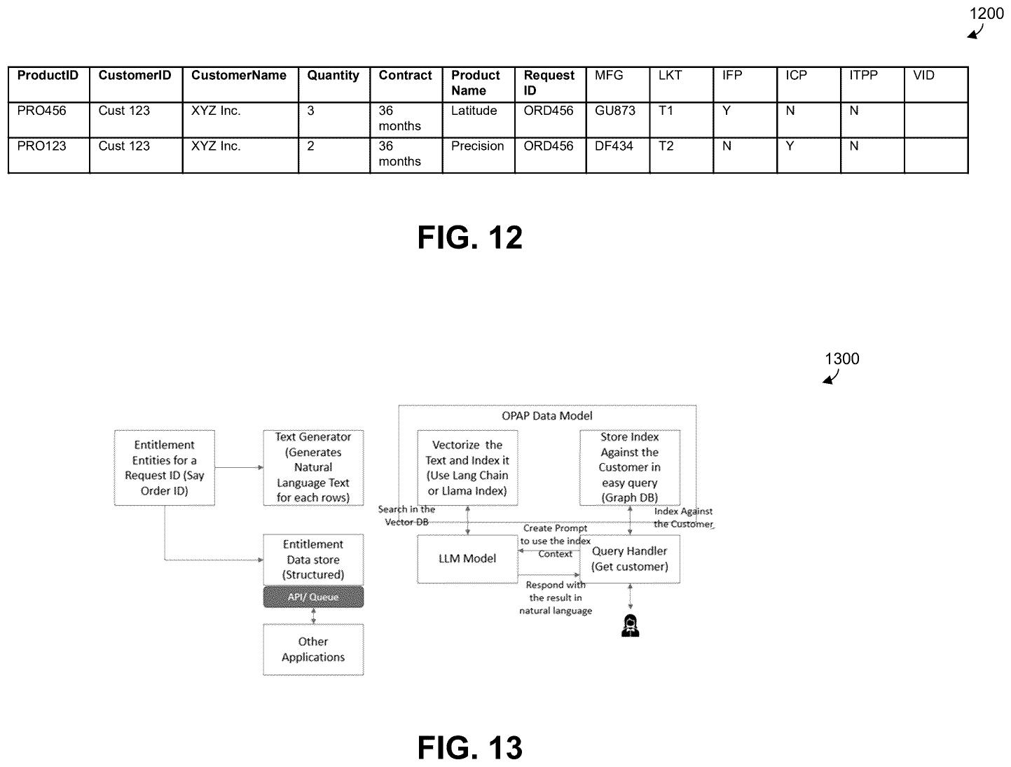

In the first process, i.e., entitlement generation for the customer queries in natural language, module 214 first converts the entitlement entities into natural text. Assume the example shown in a table 1200 in FIG. 12. Module 214 converts the data in table 1200 as follows:
1. Customer XYZ Inc. with Customer ID Cust 123 is entitled for 3 products, Latitude carrying product ID PRO456 for 36 months against Order Number ORD456.
2. Customer XYZ Inc. with Customer Id Cust 123 is entitled for 2 products, Precision carrying product ID PRO123 for 36 months against Order Number ORD456.

Each row represents one entitlement, and the template can be used to convert the structured data into an unstructured natural language text format.

This data is vectorized, indexed (using a retrieval augmentation generation or RAG) and maintained against the customer ID. RAG is a technique that supplements text generation with information from one or more other data sources. RAG is further described below in the context of an OPAP data model. Once the customer logs in and asks for the entitlement details, a large language model (LLM) can be used to perform the search on this RAG query and return the details.

In the second process, i.e., entitlement generation for computer-based applications, module 214 performs a process 1300 as illustrated in FIG. 13. Here, the data needs to be structural. Thus, table 1200 data can be kept as is or converted as per an application requirement to store in an online transaction processing (OLTP) model with a new entitlement ID created as summarized in FIG. 13.

### Usage Parameter(s) (License) Generator (Module 216)

Given the licensing model, the license is generated or a stocked license key is used for that product and give back to the requester.

Once generated, the license information is updated in the OLTP model for web pages and interlocks, and the OPAP model for the customer queries about the license.

### Feedback Loop(s) (Module 218)

Module 218 manages the various feedback loops (e.g., approval and configuration/rule update loops) described above and otherwise shown in the figures.

### Model Ensemble (AI Flow) (Module 220)

Module 220 manages the various AI models including the machine learning algorithms associated with each AI model described above and otherwise shown in the figures.

### OPAP (Module 222)

OPAP addresses secured multi-dimensional natural language-based queries through the deconstruction of structured data to LLM understandable unstructured natural language modeled via hierarchical data mapping within tenant and context boundaries, coupled with vectorized data and indices.

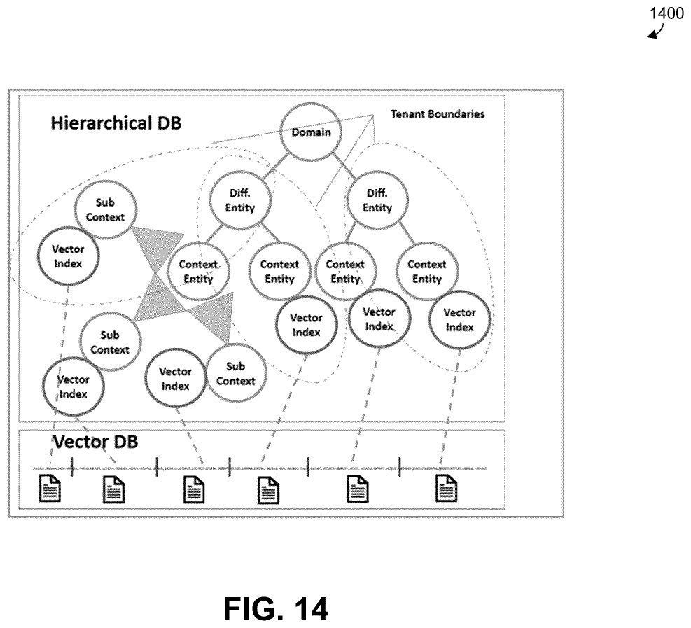

As shown in OPAP model 1400 in FIG. 14, OPAP includes the following components:
1. Domain: the high-level data segregation; typically a functional domain (e.g., online sales).
2. Differentiating entity: the highest level of data boundary under a domain (e.g., customer).
3. Context entity: different context of data, for which a user may ask (e.g., order, subscription). OPAP can be adapted to create sub-context under a specific context (e.g., under order, enterprise order and consumer order.
4. Vector index: vector index associated to the vectorized document; one to one mapping with leaf level of context entity.
5. Vectorized document: document for a specific context entity for a differentiating entity (vector database (DB)).

An OPAP model can have various sub-model types:
1. Tree schema hierarchy model for keeping the relationship between domain, differentiating entities, and context entity.
2. Tree star schema for creating different contextual dimensions under a specific context.
3. Tree snowflake schema model for referencing document(s) index-one context/sub-context can have multiple documents and multiple document indices, according to the use case.
4. One to one mapping schema for document index to document mapping.
5. Tenant boundary is a specific document index or group of indices, e.g., a differentiating entity can access for a specific context/sub-context.

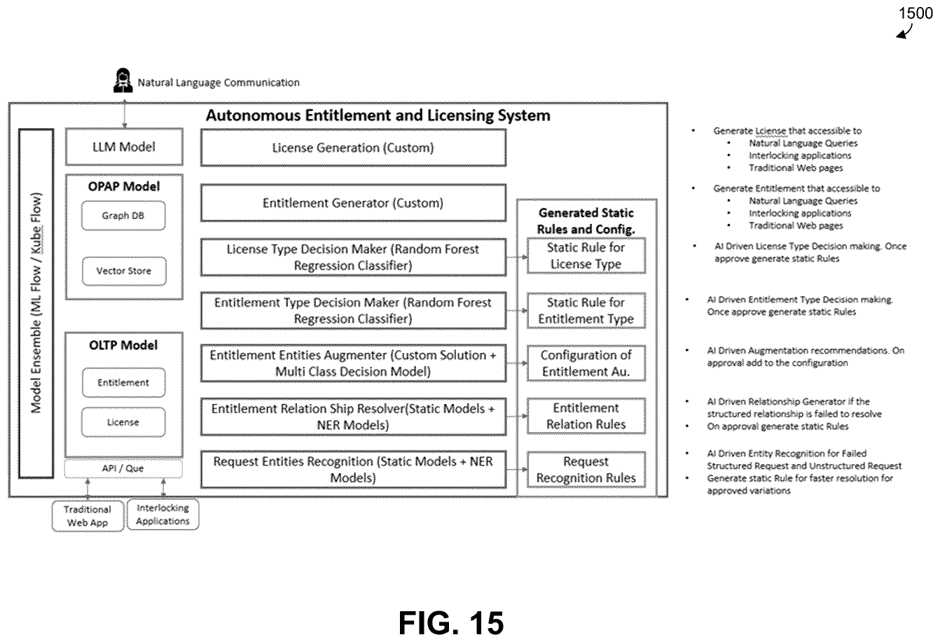

Referring now to FIG. 15, a schematic model 1500 summarizes operations and processes performed by the modules 204 through 222 of system 200 under control of controller 202, as described herein in accordance with illustrative embodiments. More particularly, schematic model 1500 depicts an autonomous entitlement (permission parameters) and license (usage parameters) generation methodology for any type of request (e.g., structured or unstructured), which learns, rectifies, and processes with minimal human intervention. Request resolution is based on one or more NER models. Entitlement entity relationship resolution uses a NER model and a multi-class decision tree model. Self-learning entitlement type and license type decisions are made using a random forest regression classification model based on entitlement data. Feedback loops for SME approval are used for AI-based decisions and then autogenerate rules upon approval. Conversion of structured entitlement and license information to natural text format is used for easy access to RAG and LLM for natural language-based conversation on entitlement and license for logged in customers.

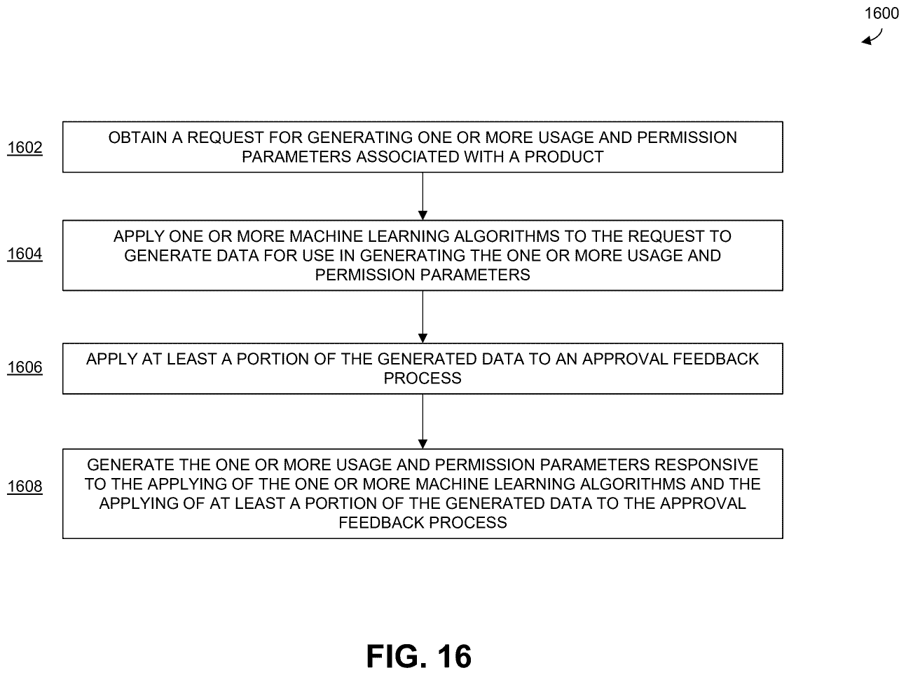

FIG. 16 shows a methodology 1600 for managing a usage and permission request associated with a product in an information processing system according to an illustrative embodiment.

Step 1602 obtains a request for generating one or more usage and permission parameters associated with a product.

Step 1604 applies one or more machine learning algorithms to the request to generate data for use in generating the one or more usage and permission parameters.

Step 1606 applies at least a portion of the generated data to an approval feedback process.

Step 1608 generates the one or more usage and permission parameters responsive to the applying steps.

In some embodiments, the request includes one or more entities, the one or more entities being at least one of structured and unstructured.

In some embodiments, applying one or more machine learning algorithms to the request further includes recognizing at least one entity of the one or more entities utilizing a named entity recognition model when the at least one entity is an unstructured entity, wherein the named entity recognition model is trained with unstructured training data.

In some embodiments, applying one or more machine learning algorithms to the request further includes recognizing at least one entity of the one or more entities utilizing a named entity recognition model when the at least one entity is a structured entity that is not otherwise recognized, wherein the named entity recognition model is trained with structured training data.

In some embodiments, the method further includes updating an entity recognition rule set to include previously recognized entities.

In some embodiments, the method further includes updating an entity recognition rule set to include a recognition rule for unrecognized entities.

In some embodiments, applying one or more machine learning algorithms to the request further includes determining one or more dependency relationships between the one or more entities in the request. Determining one or more dependency relationships between the one or more entities in the request may utilize a named entity recognition model to perform a dependency parsing process to determine the one or more dependency relationships.

In some embodiments, applying one or more machine learning algorithms to the request further includes augmenting one or more recognized entities from the request with one or more additional entities derived from one or more historical data sources. Augmenting one or more recognized entities from the request with one or more additional entities derived from one or more historical data sources may utilize a decision tree model to derive the one or more additional entities.

In some embodiments, generating the one or more usage and permission parameters further includes classifying the one or more entities using a regression classification model. Generating the one or more usage and permission parameters may further include generating at a portion of the parameters in an unstructured format and/or in a structured format.

In some embodiments, generating the one or more usage and permission parameters further includes utilizing an online prompt driven analytical processing model.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

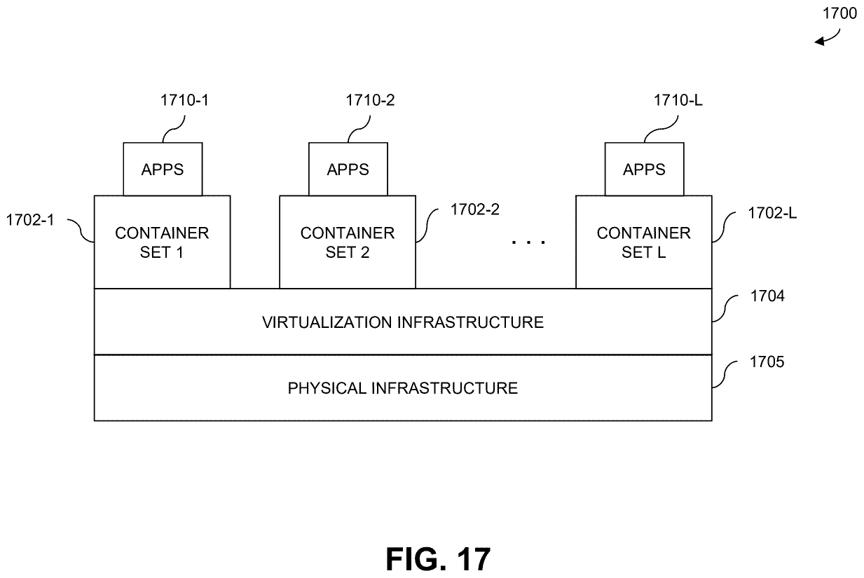

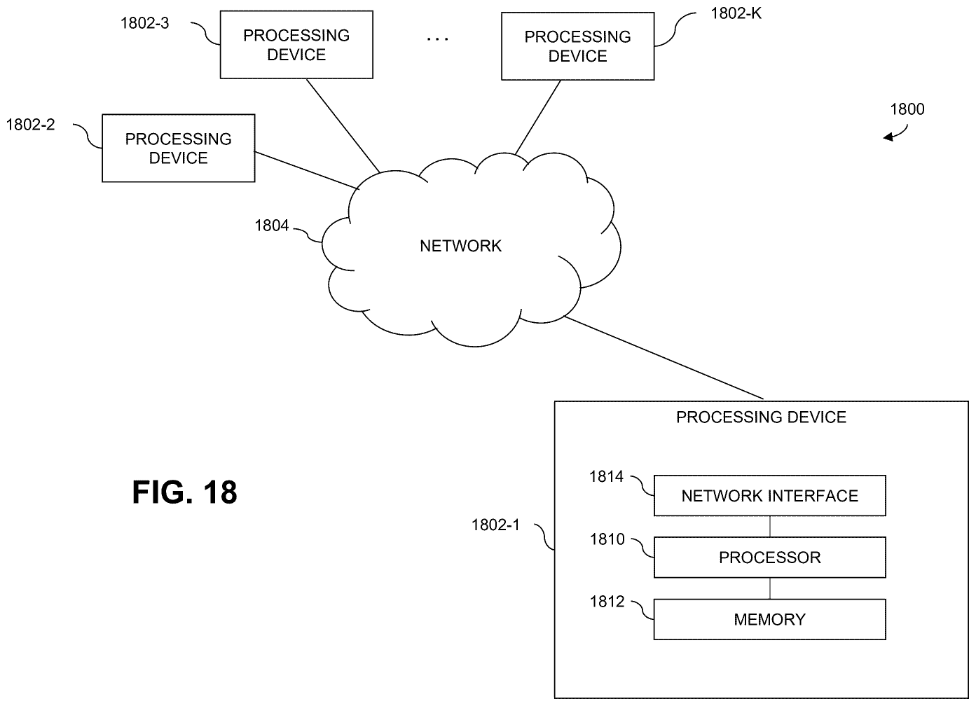

Illustrative embodiments of processing platforms utilized to implement functionality for managing usage and permissions associated with a product will now be described in greater detail with reference to FIGS. 17 and 18. Although described in the context of information processing system environment mentioned herein, these platforms may also be used to implement at least portions of other information processing systems in other embodiments.

FIG. 17 shows an example processing platform comprising infrastructure 1700. Infrastructure 1700 comprises a combination of physical and virtual processing resources that may be utilized to implement at least a portion of the information processing system 100 in FIG. 1. Infrastructure 1700 comprises multiple virtual machines (VMs) and/or container sets 1702-1, 1702-2, . . . 1702-L implemented using virtualization infrastructure 1704. The virtualization infrastructure 1704 runs on physical infrastructure 1705, and illustratively comprises one or more hypervisors and/or operating system level virtualization infrastructure. The operating system level virtualization infrastructure illustratively comprises kernel control groups of a Linux operating system or other type of operating system.

Infrastructure 1700 further comprises sets of applications 1710-1, 1710-2, . . . 1710-L running on respective ones of the VMs/container sets 1702-1, 1702-2, . . . 1702-L under the control of the virtualization infrastructure 1704. The VMs/container sets 1702 may comprise respective VMs, respective sets of one or more containers, or respective sets of one or more containers running in VMs.

In some implementations of the FIG. 17 embodiment, the VMs/container sets 1702 comprise respective VMs implemented using virtualization infrastructure 1704 that comprises at least one hypervisor. A hypervisor platform may be used to implement a hypervisor within the virtualization infrastructure 1704, where the hypervisor platform has an associated virtual infrastructure management system. The underlying physical machines may comprise one or more distributed processing platforms that include one or more storage systems.

In other implementations of the FIG. 17 embodiment, the VMs/container sets 1702 comprise respective containers implemented using virtualization infrastructure 1704 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system environments mentioned herein may each run on a computer, server, storage device or other processing platform element. A given such element may be viewed as an example of what is more generally referred to herein as a “processing device.” Infrastructure 1700 shown in FIG. 17 may represent at least a portion of one processing platform. Another example of such a processing platform is processing platform 1800 shown in FIG. 18.

The processing platform 1800 in this embodiment comprises at least a portion of information processing system 100 and includes a plurality of processing devices, denoted 1802-1, 1802-2, 1802-3, . . . 1802-K, which communicate with one another over a network 1804.

The network 1804 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1802-1 in the processing platform 1800 comprises a processor 1810 coupled to a memory 1812.

The processor 1810 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1812 may comprise random access memory (RAM), read-only memory (ROM), flash memory or other types of memory, in any combination. The memory 1812 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1802-1 is network interface circuitry 1814, which is used to interface the processing device with the network 1804 and other system components, and may comprise conventional transceivers.

The other processing devices 1802 of the processing platform 1800 are assumed to be configured in a manner similar to that shown for processing device 1802-1 in the figure.

Again, the particular processing platform 1800 shown in the figure is presented by way of example only, and information processing system environments mentioned herein may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for application monitoring with predictive anomaly detection and fault isolation as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, edge computing environments, applications, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
obtaining a request for generating one or more usage and permission parameters associated with a product;
applying one or more machine learning algorithms to the request to generate data for use in generating the one or more usage and permission parameters;
applying at least a portion of the generated data to an approval feedback process; and
generating the one or more usage and permission parameters responsive to the applying steps;
wherein the above steps are performed in accordance with a processing device comprising a processor operatively coupled to a memory and configured to execute program code.

2. The method of claim 1, wherein the request comprises one or more entities, the one or more entities being at least one of structured and unstructured.

3. The method of claim 2, wherein applying one or more machine learning algorithms to the request further comprises recognizing at least one entity of the one or more entities utilizing a named entity recognition model when the at least one entity is an unstructured entity, wherein the named entity recognition model is trained with unstructured training data.

4. The method of claim 2, wherein applying one or more machine learning algorithms to the request further comprises recognizing at least one entity of the one or more entities utilizing a named entity recognition model when the at least one entity is a structured entity that is not otherwise recognized, wherein the named entity recognition model is trained with structured training data.

5. The method of claim 2, further comprising updating an entity recognition rule set to include previously recognized entities.

6. The method of claim 2, further comprising updating an entity recognition rule set to include a recognition rule for unrecognized entities.

7. The method of claim 2, wherein applying one or more machine learning algorithms to the request further comprises determining one or more dependency relationships between the one or more entities in the request.

8. The method of claim 7, wherein determining one or more dependency relationships between the one or more entities in the request utilizes a named entity recognition model to perform a dependency parsing process to determine the one or more dependency relationships.

9. The method of claim 2, wherein applying one or more machine learning algorithms to the request further comprises augmenting one or more recognized entities from the request with one or more additional entities derived from one or more historical data sources.

10. The method of claim 9, wherein augmenting one or more recognized entities from the request with one or more additional entities derived from one or more historical data sources utilizes a decision tree model to derive the one or more additional entities.

11. The method of claim 2, wherein generating the one or more usage and permission parameters further comprises classifying the one or more entities using a regression classification model.

12. The method of claim 2, wherein generating the one or more usage and permission parameters further comprises generating at a portion of the one or more usage and permission parameters in an unstructured format.

13. The method of claim 2, wherein generating the one or more usage and permission parameters further comprises generating at a portion of the one or more usage and permission parameters in a structured format.

14. The method of claim 2, wherein generating the one or more usage and permission parameters further comprises utilizing an online prompt driven analytical processing model.

15. An apparatus comprising:
at least one processing platform comprising at least one processor coupled to at least one memory, the at least one processing platform, when executing program code, is configured to:
obtain a request for generating one or more usage and permission parameters associated with a product;
apply one or more machine learning algorithms to the request to generate data for use in generating the one or more usage and permission parameters;
apply at least a portion of the generated data to an approval feedback process; and
generate the one or more usage and permission parameters responsive to the applying of the one or more machine learning algorithms and the applying of at least a portion of the generated data to the approval feedback process.

16. The apparatus of claim 15, wherein the request comprises one or more entities, the one or more entities being at least one of structured and unstructured.

17. The apparatus of claim 16, wherein applying one or more machine learning algorithms to the request further comprises one or more of:
recognizing at least one entity of the one or more entities utilizing a named entity recognition model when the at least one entity is an unstructured entity, wherein the named entity recognition model is trained with unstructured training data;
recognizing at least one entity of the one or more entities utilizing a named entity recognition model when the at least one entity is a structured entity that is not otherwise recognized, wherein the named entity recognition model is trained with structured training data;
updating an entity recognition rule set to include previously recognized entities; and
updating an entity recognition rule set to include a recognition rule for unrecognized entities.

18. A computer program product comprising a non-transitory processor-readable storage medium having stored therein program code of one or more software programs, wherein the program code when executed by at least one processing device causes the at least one processing device to:
obtain a request for generating one or more usage and permission parameters associated with a product;
apply one or more machine learning algorithms to the request to generate data for use in generating the one or more usage and permission parameters;
apply at least a portion of the generated data to an approval feedback process; and
generate the one or more usage and permission parameters responsive to the applying of the one or more machine learning algorithms and the applying of at least a portion of the generated data to the approval feedback process.

19. The computer program product of claim 18, wherein the request comprises one or more entities, the one or more entities being at least one of structured and unstructured.

20. The computer program product of claim 19, wherein applying one or more machine learning algorithms to the request further comprises one or more of:
recognizing at least one entity of the one or more entities utilizing a named entity recognition model when the at least one entity is an unstructured entity, wherein the named entity recognition model is trained with unstructured training data;
recognizing at least one entity of the one or more entities utilizing a named entity recognition model when the at least one entity is a structured entity that is not otherwise recognized, wherein the named entity recognition model is trained with structured training data;
updating an entity recognition rule set to include previously recognized entities; and
updating an entity recognition rule set to include a recognition rule for unrecognized entities.
